(19) United States
(12) Patent Application Publication
(10) Pub. No.: US 2025/0300214 A1
(43) Pub. Date: Sep. 25, 2025

(54) METHOD OF HEAT-PRESSING ELECTRODE ASSEMBLY, AND SECONDARY BATTERY AND MANUFACTURING METHOD THEREOF USING THE SAME

(71) Applicant: Samsung SDI Co., Ltd., Yongin-si (KR)

(72) Inventor: KIYOUN JEON, Yongin-si (KR)

(21) Appl. No.: 18/913,719

(22) Filed: Oct. 11, 2024

(30) Foreign Application Priority Data
Mar. 19, 2024 (KR) 10-2024-0037675

(51) Int. Cl. H01M 10/04; B60L 50/64; H01M 50/105; H01M 50/119

(52) U.S. Cl. CPC H01M 10/0468; H01M 10/049; H01M 50/105; H01M 50/119; B60L 50/64; H01M 2220/20

(57) ABSTRACT

A method of heat-pressing a secondary battery electrode assembly includes: manufacturing an electrode assembly; inputting the electrode assembly into a flexible electrolyte bag containing an electrolyte; and heat pressing, from the outside of the electrolyte bag, the electrode assembly immersed in the electrolyte to bind electrode plates of the electrode assembly.

### CROSS-REFERENCE TO RELATED APPLICATION

The present application claims priority to and the benefit of Korean Patent Application No. 10-2024-0037675, filed on Mar. 19, 2024, in the Korean Intellectual Property Office, the entire disclosure of which is incorporated herein by reference.

### BACKGROUND

### 1. Field

Aspects of embodiments of the present disclosure relate to a method of heat-pressing an electrode assembly, a secondary battery using the same, and a method of manufacturing secondary batteries using the same.

### 2. Description of the Related Art

Different from primary batteries that are not designed to be (re) charged, secondary batteries are designed to be discharged and recharged. Generally, a secondary battery includes an electrode assembly including (or composed of) a positive electrode plate, a negative electrode plate, and a separator, and an enclosure (e.g., a case or can) accommodating the electrode assembly. The electrode assembly may be classified into a wound electrode assembly or a laminated electrode assembly depending on how the electrode plates and separator are stacked. The wound electrode assembly may be in the form of a jelly roll, and the laminated electrode assembly may be in the form of a stack. In addition, the secondary battery may be classified as a pouch-type secondary battery, a cylindrical secondary battery, a prismatic secondary battery, etc., depending on the material and shape of the enclosure.

To increase the energy density of the electrode assembly accommodated in the enclosure, which has a certain volume, and to control the thickness of the electrode assembly, the secondary battery may be formed by using a heat pressing or heat press & charge (HPC) process for binding the electrode plates of the electrode assembly.

In the pouch-type secondary battery, it is relatively easy to seal the electrode assembly in the pouch and heat press the electrode assembly together with the pouch. However, in a secondary battery using a metal (e.g., a rigid metal) enclosure, it is difficult to perform heat pressing on the electrode assembly because it has no gas pocket unlike the pouch-type secondary battery.

The above information disclosed in this Background section is for enhancement of understanding of the background of the present disclosure, and therefore, it may contain information that does not constitute the related (or prior) art.

### SUMMARY

Embodiments of the present disclosure provide a method of heat-pressing an electrode assembly before it is sealed in an enclosure to bind electrode plates thereof and a method of manufacturing secondary batteries using the same.

According to an embodiment, a method of heat-pressing a secondary battery electrode assembly includes manufacturing an electrode assembly, inputting the electrode assembly into a flexible electrolyte bag containing an electrolyte, and heat pressing, from the outside of the electrolyte bag, the electrode assembly immersed in the electrolyte to bind electrode plates of the electrode assembly.

According to another embodiment, a secondary battery includes an electrode assembly manufactured by heat-pressing the electrode assembly as described above and an enclosure accommodating the electrode assembly.

According to another embodiment, a method of manufacturing a secondary battery includes manufacturing an electrode assembly, inputting the electrode assembly into a flexible electrolyte bag containing an electrolyte, heat pressing, from the outside of the electrolyte bag, the electrode assembly immersed in the electrolyte to bind electrode plates of the electrode assembly, separating the electrolyte bag to extract the electrode assembly with bound electrode plates, and inserting and sealing the extracted electrode assembly in an enclosure.

Aspects and features of the present disclosure is not limited to the above described aspects and features, and other aspects and features not expressly mentioned herein will be clearly understood by those skilled in the art from the description of the present disclosure set forth below.

### BRIEF DESCRIPTION OF THE DRAWINGS

The following drawings attached to the present specification illustrate embodiments of the present disclosure and further describe aspects and features of the present disclosure together with the detailed description of the present disclosure. Thus, the present disclosure should not be construed as being limited to the drawings:

FIG. 1 schematically illustrates an electrode assembly of a secondary battery according to some embodiments of the present disclosure;

FIG. 2 schematically illustrates a pouch-type secondary battery;

FIG. 3 schematically illustrates a prismatic secondary battery according to some embodiments of the present disclosure;

FIG. 4 is a flowchart describing a method of manufacturing secondary batteries according to an embodiment of the present disclosure;

FIG. 5 illustrates a semi-finished electrode assembly immersed in an electrolyte contained in an electrolyte bag;

FIG. 6 schematically illustrates a heat pressing method according to some embodiments of the present disclosure;

FIG. 7 schematically illustrates another heat pressing method according to some embodiments of the present disclosure;

FIG. 8 is a schematic view illustrating an electrode assembly sealed in a vertical secondary battery case;

FIG. 9 a schematic view illustrating an electrode assembly sealed in a horizontal secondary battery case;

FIG. 10 is a flowchart describing a method of manufacturing secondary batteries according to other embodiments of the present disclosure;

FIG. 11 is a flowchart describing a method of manufacturing secondary batteries according to other embodiments of the present disclosure;

FIG. 12 is a view of a secondary battery module in which secondary batteries are arranged according to one or more embodiments of the present disclosure;

FIG. 13 is a view of a secondary battery pack including the secondary battery module illustrated in FIG. 12; and

FIG. 14 is a schematic, conceptual view of a vehicle including the secondary battery pack illustrated in FIG. 13.

### DETAILED DESCRIPTION

Hereinafter, embodiments of the present disclosure will be described, in detail, with reference to the accompanying drawings. The terms or words used in the present specification and claims are not to be limitedly interpreted according to their general or dictionary meanings and should be interpreted as having meanings and describing concepts that are consistent with the technical idea of the present disclosure on the basis of the principle that an inventor can be his/her own lexicographer to appropriately define concepts of terms to describe his/her invention in the best way.

The embodiments described in this specification and the configurations shown in the drawings are only some of the embodiments of the present disclosure and do not represent all of the aspects and features of the present disclosure. Accordingly, it should be understood that there may be various equivalents and modifications that can replace or modify one or more embodiments described herein at the time of filing this application.

It will be understood that if an element or layer is referred to as being “on,” “connected to,” or “coupled to” another element or layer, it may be directly on, connected, or coupled to the other element or layer or one or more intervening elements or layers may also be present. When an element or layer is referred to as being “directly on,” “directly connected to,” or “directly coupled to” another element or layer, there are no intervening elements or layers present. For example, if a first element is described as being “coupled” or “connected” to a second element, the first element may be directly coupled or connected to the second element or the first element may be indirectly coupled or connected to the second element via one or more intervening elements.

In the figures, dimensions of the various elements, layers, etc. may be exaggerated for clarity of illustration. The same reference numerals designate the same elements. As used herein, the term “and/or” includes any and all combinations of one or more of the associated listed items. Further, the use of “may” if describing embodiments of the present disclosure relates to “one or more embodiments of the present disclosure.” Expressions, such as “at least one of” and “any one of,” if preceding a list of elements, modify the entire list of elements and do not modify the individual elements of the list. When phrases such as “at least one of” A, B and C, “at least one of A, B or C,” “at least one selected from a group of A, B and C,” or “at least one selected from among A, B and C” are used to designate a list of elements A, B and C, the phrase may refer to any and all suitable combinations or a subset of A, B and C, such as A, B, C, A and B, A and C, B and C, or A and B and C. As used herein, the terms “use,” “using,” and “used” may be considered synonymous with the terms “utilize,” “utilizing,” and “utilized,” respectively. As used herein, the terms “substantially,” “about,” and similar terms are used as terms of approximation and not as terms of degree, and are intended to account for the inherent variations in measured or calculated values that would be recognized by those of ordinary skill in the art.

It will be understood that, although the terms first, second, third, etc. may be used herein to describe various elements, components, regions, layers, and/or sections, these elements, components, regions, layers, and/or sections should not be limited by these terms. These terms are used to distinguish one element, component, region, layer, or section from another element, component, region, layer, or section. Thus, a first element, component, region, layer, or section discussed below could be termed a second element, component, region, layer, or section without departing from the teachings of example embodiments.

Spatially relative terms, such as “beneath,” “below,” “lower,” “above,” “upper,” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

The terminology used herein is for the purpose of describing embodiments of the present disclosure and is not intended to be limiting of the present disclosure. As used herein, the singular forms “a” and “an” are intended to include the plural forms as well, unless the context clearly indicates otherwise. It will be further understood that the terms “includes,” “including,” “comprises,” and/or “comprising,” if used in this specification, specify the presence of stated features, integers, steps, operations, elements, and/or components but do not preclude the presence or addition of one or more other features, integers, steps, operations, elements, components, and/or groups thereof.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein, and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein. All such ranges are intended to be inherently described in this specification such that amending to expressly recite any such subranges would comply with the requirements of 35 U.S.C. § 112(a) and 35 U.S.C. § 132(a).

References to two compared elements, features, etc. as being “the same” may mean that they are “substantially the same.” Thus, the phrase “substantially the same” may include a case having a deviation that is considered low in the art, for example, a deviation of about 5% or less. In addition, if a certain parameter is referred to as being uniform in a given region, it may mean that it is uniform in terms of an average.

Throughout the specification, unless otherwise stated, each element may be singular or plural.

Arranging an arbitrary element “above (or below)” or “on (under)” another element may mean that the arbitrary element may contact the upper (or lower) surface of the element, and another element may also be interposed between the element and the arbitrary element located on (or under) the element.

In addition, it will be understood that if a component is referred to as being “linked,” “coupled,” or “connected” to another component, the elements may be directly “coupled,” “linked” or “connected” to each other, or another component may be “interposed” between the components.”

Throughout the specification, if “A and/or B” is stated, it means A, B or A and B, unless otherwise stated. That is, “and/or” includes any or all combinations of a plurality of items enumerated. When “C to D” is stated, it means C or more and D or less, unless otherwise specified.

The terminology used herein is for the purpose of describing embodiments of the present disclosure and is not intended to limit the present disclosure.

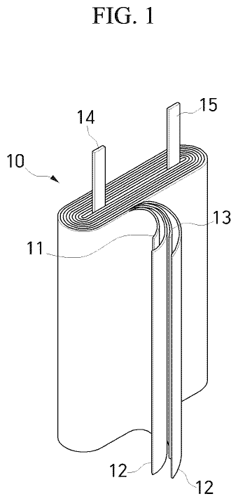

FIG. 1 shows an electrode assembly of a secondary battery.

Referring to FIG. 1, an electrode assembly 10 may be formed by winding or stacking a stack of a first electrode plate 11, a separator 12, and a second electrode plate 13, each of which are formed as thin plates or films. When the electrode assembly 10 is a wound stack, a winding axis may be parallel to the longitudinal direction of a case. In other embodiments, the electrode assembly 10 may be a stack type rather than a winding type, and the shape of the electrode assembly 10 is not limited in the present disclosure. In addition, the electrode assembly 10 may be a Z-stack electrode assembly in which a positive electrode plate and a negative electrode plate are inserted into both sides (e.g., opposite sides) of a separator, which is then bent (or folded) into a Z-stack. In addition, one or more electrode assemblies may be stacked (e.g., arranged) such that long sides of the electrode assemblies are adjacent to each other and accommodated in a case, and the number of electrode assemblies in a case is not limited in the present disclosure. The first electrode plate 11 of the electrode assembly may act as a negative electrode, and the second electrode plate 13 may act as a positive electrode. Of course, the reverse is also possible.

The first electrode plate 11 may be formed by applying (e.g., coating or depositing) a first electrode active material, such as graphite or carbon, onto a first electrode substrate formed of a metal foil, such as copper, a copper alloy, nickel, or a nickel alloy. The first electrode plate 11 may include a first electrode tab 14 (e.g., a first uncoated portion), which is a region to which the first electrode active material is not applied. The first electrode tab 14 may be connected to an external first terminal. In some embodiments, when the first electrode plate 11 is manufactured, the first electrode tab 14 may be formed by being cut in advance to protrude to (or protrude from) one side of the electrode assembly 10, or the first electrode tab 14 may protrude to one side of the electrode assembly 10 more than (e.g., farther than or beyond) the separator 12 without being separately cut.

The second electrode plate 13 may be formed by applying (e.g., coating or depositing) a second electrode active material, such as a transition metal oxide, onto a second electrode substrate formed of a metal foil, such as aluminum or an aluminum alloy. The second electrode plate 13 may include a second electrode tab 15 (e.g., a second uncoated portion), which is a region to which the second electrode active material is not applied. The second electrode tab 15 may be connected to an external second terminal. In some embodiments, the second electrode tab 15 may be formed by being cut in advance to protrude to the other side (e.g., the opposite side) of the electrode assembly 10 when the second electrode plate 13 is manufactured, or the second electrode plate 13 may protrude to the other side of the electrode assembly more than (e.g., farther than or beyond) the separator 12 without being separately cut.

The separator 12 prevents a short-circuit between the first electrode plate 11 and the second electrode plate 13 while allowing movement of lithium ions therebetween. The separator 12 may be made of, for example, a polyethylene film, a polypropylene film, a polyethylene-polypropylene film, or the like.

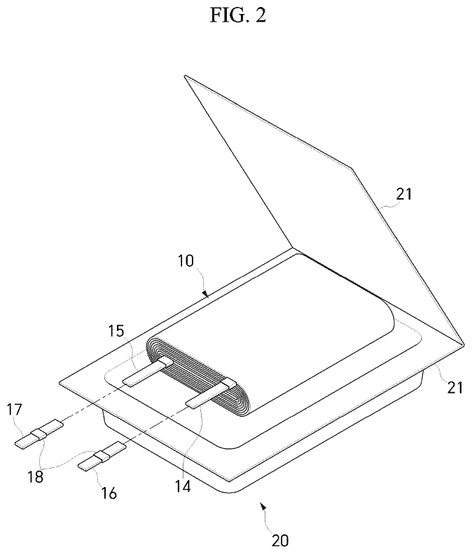

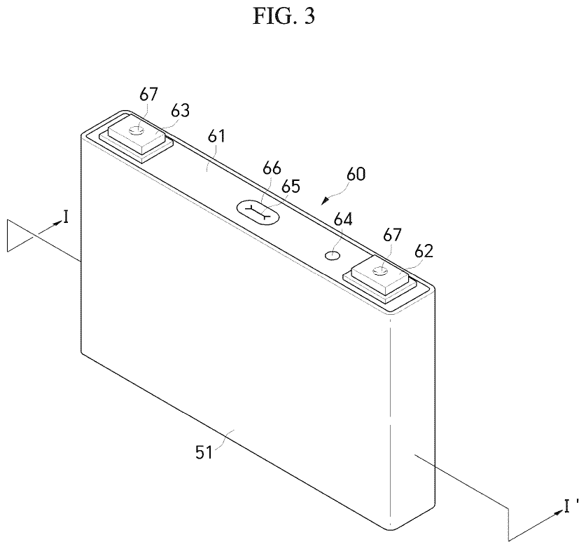

In some embodiments, the electrode assembly 10 may be accommodated in a case along with an electrolyte. In a pouch-type secondary battery, an electrode assembly 10 may be accommodated in a pouch made of flexible material (see, e.g., FIG. 2). In a cylindrical or prismatic secondary battery, an electrode assembly 10 may be accommodated in a cylindrical or prismatic metal casing (see, e.g., FIG. 3).

FIG. 2 schematically illustrates the pouch-type secondary battery.

The pouch-type secondary battery includes an electrode assembly 10 and a pouch 20 that accommodates the electrode assembly 10.

The electrode assembly 10 may be the same as that illustrated in FIG. 1. The first electrode tab 14 and the second electrode tab 15 of the electrode assembly 10 may be electrically connected to respective external first and second terminal leads 16 and 17 by welding. Each of the first terminal lead 16 and the second terminal lead 17 may be attached with (e.g., covered by) a tab film 18 for insulation from the pouch 20.

The pouch 20 may be sealed by having sealing parts 21 at the edges thereof come into contact with each other while accommodating the electrode assembly 10 therein, and the sealing may be achieved with the tab film 18 interposed between the sealing parts 21. The sealing parts 21 of the pouch 20 may each be made of a thermal fusion material that generally exhibits weak adhesion to metal. Thus, the pouch 20 may be fused together by interposing the thin film 18 between the sealing parts 21 to ensure a sufficient seal.

FIG. 3 is a top perspective view of a prismatic secondary battery according to some embodiments of the present disclosure.

A case 51 defines an overall appearance of the prismatic secondary battery and may be made of (or may include) a conductive metal, such as aluminum, aluminum alloy, or nickel-plated steel. In addition, the case 51 may provide (or may form) a space for accommodating the electrode assembly 10 therein.

A cap assembly 60 may include a cap plate 61 that covers (e.g., seals) the opening in the case 51. In some embodiments, the cap plate 61 may be made of a conductive material. A first terminal 63 and a second terminal 62 may be electrically connected to respective positive and negative (or negative and positive) electrodes inside the case 51 and may be installed to protrude outwardly through the cap plate 61.

The cap plate 61 may have an electrolyte injection port 64 with a sealing plug (or seal pin) therein and a vent 66 having a notch 65. The vent 66 is configured to discharge gas (e.g., to discharge excess gas) generated inside the secondary battery.

To increase the energy density of the electrode assembly, to activate ionic behavior, and to improve the degree of integration in the limited internal space in the enclosure or case, the thickness of lamination of the electrode assembly may be controlled. A heat pressing process may be used during manufacturing to control the thickness of the electrode assembly. For example, the process of heat pressing while charging the battery is referred to as heat press & charge (HPC). This heat pressing process may be used during activation the completed electrode assembly is inserted into the battery enclosure and injected with electrolyte. Therefore, it is common to use this method in connection with the pouch-type secondary battery with a flexible enclosure and a separate gas pocket.

For example, because the pouch-type battery has a separate gas pocket next to the pocket where the electrode assembly is arranged to allow for injection of the electrolyte and to collect unnecessary gas, different from the cylindrical or prismatic secondary battery in which the electrode assembly is accommodated in the metal-like enclosure, the heat pressing process may be carried out when the electrode assembly sealed in the pouch and injected with electrolyte. The gas pocket where gas and excess electrolyte are collected is cut out and removed in a later (or final) step.

However, because the secondary battery sealed in the metal enclosure (e.g., a prismatic secondary battery having metal case) has no gas pocket, the heat pressing may not be performed after the electrode assembly is inserted and sealed in the enclosure, and even if this is attempted, the enclosure may break. In such an embodiment, the thickness of the electrode assembly may be controlled by using a negative pressure method. However, even if the negative pressure method is used, it is difficult to press the electrode assembly after it is sealed in the enclosure. In addition, even when it is possible to press the center of the electrode assembly because the enclosure allows for some degree of movement when the electrode assembly sealed therein, other characteristics may deteriorate because the electrode plates are not bound (or attached) uniformly over the entire area of the electrode assembly.

Accordingly, embodiments of present disclosure provide a method of binding electrode plates of an electrode assembly by performing heat pressing or HPC on the electrode assembly before it is sealed in an enclosure (e.g., a case or can) and a secondary battery manufactured using the method.

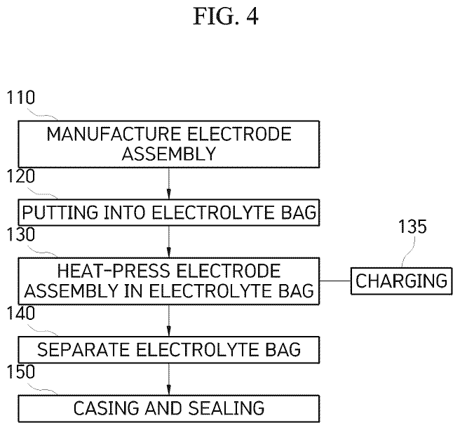

FIG. 4 is a flowchart describing a method of manufacturing a secondary battery by using a heat pressing (or HPC) method on an electrode assembly according to an embodiment of the present disclosure. The method of manufacturing a secondary battery according to this embodiment may include manufacturing an electrode assembly (110), putting (or placing or inputting) the electrode assembly into a flexible electrolyte bag containing an electrolyte (120), performing heat pressing from the outside of the electrolyte bag to bind the electrode plates of the electrode assembly that are immersed in the electrolyte (130), separating (or opening) the electrolyte bag to extract the electrode assembly having bound electrode plates (140), and inserting and sealing the extracted electrode assembly in an enclosure (150). In this embodiment, the heat pressing (130) may be carried out together with (e.g., concurrently or simultaneously with) charging the electrode assembly (135). Charging along with heat pressing is also called HPC, as mentioned above.

Now, each step described in FIG. 4 will be described in more detail.

Reference numeral 110 refers to manufacturing the electrode assembly.

As described with reference to FIG. 1, the electrode assembly 10 may be manufactured by winding or stacking the first electrode plate 11, the separator 12, and the second electrode plate 13. The first electrode plate 11 may be manufactured by applying an active material, such as graphite or carbon, to a substrate made of a metal foil, such as copper, a copper alloy, nickel, or a nickel alloy. The second electrode plate 13 may be manufactured by applying an active material, such as a lithium transition metal oxide, to a substrate made of a metal foil, such as aluminum or an aluminum alloy. The separator 12 may be made of a polyethylene film, a polypropylene film, a polyethylene-polypropylene film, or the like. The first electrode plate 11 and the second electrode plate 13 may be in the form of a jelly roll or in the form of a stack, with the separator 12 therebetween. For charging during heat pressing later, the first electrode tab 14 (see, e.g., FIG. 1) and the second electrode tab 15 (see, e.g., FIG. 1) may be formed on the uncoated parts of the first electrode plate 11 and the second electrode plate 13, respectively.

This wound or laminated electrode assembly will be referred to as a “semi-finished electrode assembly”. Because the respective electrode plates in the semi-finished electrode assembly have a weak bind (or are weakly bound), the electrode plates may be temporarily bound by attaching tape to a portion thereof.

Reference numeral 120 refers to inputting the electrode assembly into the electrolyte bag.

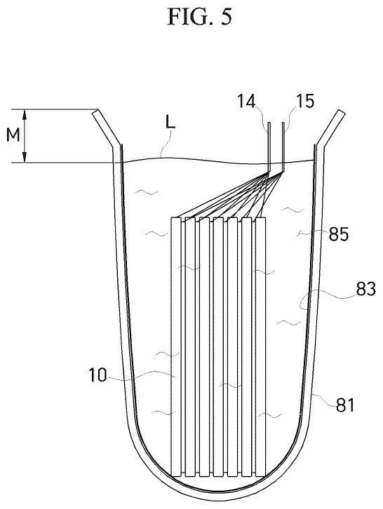

FIG. 5 illustrates a semi-finished electrode assembly 10 immersed in an electrolyte 85 contained in an electrolyte bag 81.

The electrolyte bag 81 may be made of a material similar to that of the pouch, that is, an enclosure of a pouch-type battery. For example, the electrolyte bag 81 may be made of a multilayered polymer material similar to the enclosure of the pouch-type battery. However, in this embodiment, because the electrolyte bag 81 is later separated and removed (e.g., only temporarily accommodates the semi-finished electrode assembly 10, the electrolyte bag 81 may not have a multilayer structure as the enclosure of the pouch-type battery would.

To facilitate the separation of the electrolyte bag in step 140, a release layer 83 may be formed by coating a release agent or a metal layer, or attaching a release film, on the inner wall of the electrolyte bag 81. The release layer 83 acts to easily separate the electrolyte bag 81 in step 140 after heat-pressing the semi-finished electrode assembly 10 together with the electrolyte bag 81 in step 130. The release agent may be made from a composition containing materials such as silicone or epoxy, and the release film may be manufactured by adding functional particles to a film made of PET or silicone. The metal layer may be deposited on the base material of the electrolyte bag 81 by techniques such as sputtering, CVD, PVD, etc.

The size of the electrolyte bag 81 may depend on the size of the semi-finished electrode assembly 10, the number of electrode plates, etc. The size and/or volume of the electrolyte bag 81 may be sufficient to allow the electrolyte 85 to penetrate throughout the electrode plates of the semi-finished electrode assembly 10.

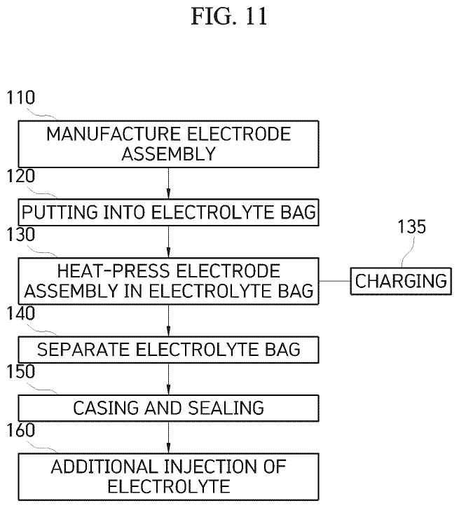

The electrolyte 85 contained in the electrolyte bag 81 may have the same composition as the electrolyte injected after sealing in the enclosure (e.g., the case or can). For example, the electrolyte for lithium secondary batteries may include a non-aqueous organic solvent and a lithium salt. The non-aqueous organic solvent may be a carbonate-based, an ester-based, an ether-based, a ketone-based, or an alcohol-based solvent, an aprotic solvent, or a combination thereof, and may be used alone or in combination of two or more. In another embodiment, the electrolyte 85 contained in the electrolyte bag 81 may omit additives that are present in the regular electrolyte injected after sealing in the enclosure. In such an embodiment, the method may further include a step of additionally injecting a regular electrolyte after step 150 of FIG. 4 (see, e.g., FIG. 11).

The level L of the electrolyte 85 contained in the electrolyte bag 81 may be sufficient to fully immerse the semi-finished electrode assembly 10. However, the level L of the electrolyte may be set such that the first electrode tab 14 and the second electrode tab 15 extend out of the electrolyte 85 without being immersed therein. For charging the battery in step 135 and for welding to seal the enclosure in step 150, the first electrode tab 14 and the second electrode tab 15 should be free of electrolyte, as much as possible.

In addition, the distance margin M between the level L of the electrolyte and the end (e.g., the top) of the opening in the electrolyte bag 81 may be set such that the electrolyte 85 does not overflow from the electrolyte bag 81 when the electrode assembly 10 is immersed.

FIG. 5 is a schematic view for explaining step 120. In actual implementation, other elements may be used or required, such as a structure for supporting the electrolyte bag 81, a cover for covering the top of the electrolyte bag 81, a holder for gripping the semi-finished electrode assembly 10 immersed in the electrolyte 85, and the like.

Reference numeral 130 refers to a step of performing heat pressing on the semi-finished electrode assembly accommodated in the electrolyte bag.

As illustrated in FIG. 5, in step 130, the heat pressing is performed on the semi-finished electrode assembly 10 together with the electrolyte bag 81 from the outside of the electrolyte bag 81 with the semi-finished electrode assembly 10 immersed in the electrolyte 85 contained in the electrolyte bag 81.

The heat pressing may be performed after waiting a reference (or predetermined time), such as about 2 to 3 hours, to allow the electrolyte to sufficiently penetrate between the wound or laminated electrode plates.

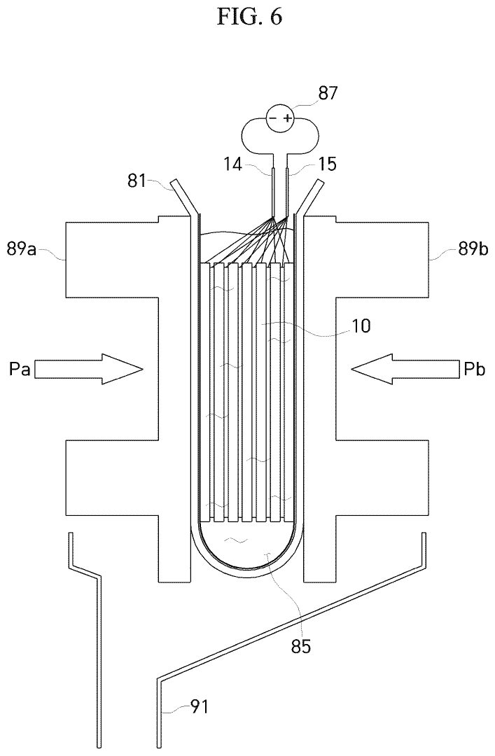

FIG. 6 schematically illustrates an example heat pressing method.

With the semi-finished electrode assembly 10 immersed in the electrolyte 85 contained in the electrolyte bag 81, the semi-finished electrode assembly 10 may be pressed from both sides thereof by a first heat press 89a and a second heat press 89b.

In FIG. 6, the first heat press 89a may apply heat and pressure to the semi-finished electrode assembly 10 together with the electrolyte bag 81 from the left thereof at a pressure Pa, and the second heat press 89b may apply heat and pressure to the semi-finished electrode assembly 10 together with the electrolyte bag 81 from the right thereof at a pressure Pb.

The compression rate of the electrode plates of the semi-finished electrode assembly 10 may be, for example, about 50%. This compression rate may be determined (or set) depending on the capacity of the secondary battery, the thickness of the electrode plates, the size of the electrode assembly, etc. To achieve the compression rate as a determined value, the pressures Pa and Pb may be set to be equal or different. The pressures Pa and Pb may be set by the operator or automatically.

In addition, the heating temperatures of the first heat press 89a and the heat press 89b may be set to be equal or different. Like the above pressures, the heating temperatures may be set by the operator or automatically.

Charging may be performed by connecting a power source 87 to the electrode tabs 14 and 15 of the semi-finished electrode assembly 10 along with heat pressing by the heat presses 89a and 89b. Even the semi-finished electrode assembly 10 may be charged because it may be immersed in the electrolyte 85 and may function as a secondary battery. The amount of charge may be a full-charge or a pre-charge of about 20%.

In this step, because the semi-finished electrode assembly 10 immersed in the electrolyte 85 is compressed from the outside of the electrolyte bag 81, the electrolyte 85 may overflow from the opening of the electrolyte bag 81. In such an embodiment, a drain 91 may be additionally installed to collect and discharge the overflowing electrolyte 85.

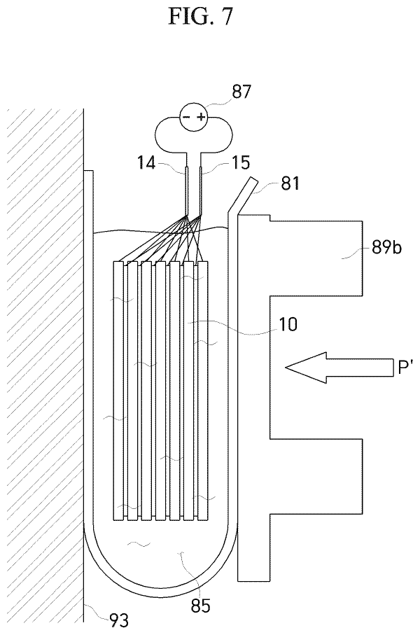

FIG. 6 illustrates an example in which the pair of first and second heat presses 89a and 89b heat-press the electrolyte bag 81 accommodating the semi-finished electrode assembly 10 from both sides thereof. On the other hand, FIG. 7 illustrates another embodiment in which a support wall 93 stands in place of the first heat press 89a and a single heat press 89b presses the electrolyte bag 81 from one side thereof at a pressure of P′ against the support wall 93.

FIGS. 6 and 7 are schematic views for explaining the step 130. In actual implementation, other elements may be used and/or required, such as a structure for supporting the electrolyte bag 81, a holder for gripping the semi-finished electrode assembly 10 immersed in the electrolyte 85, a heating and pressing facility including heat presses 89a and 89b, a processor for automatic control, and an operator control panel.

Reference numeral 140 refers to a step of separating the electrolyte bag and extracting the electrode assembly.

After the heat pressing is completed, the electrolyte bag 81 is separated and the electrode assembly with bound (e.g., completely bound) electrode plates 10′ is extracted.

It has been previously described that the release layer 83 may be formed on the inner wall of the electrolyte bag 81 for the purpose of performing this step.

Reference numeral 150 refers to a step of inserting and sealing the electrode assembly with completed binding of electrode plates in the enclosure.

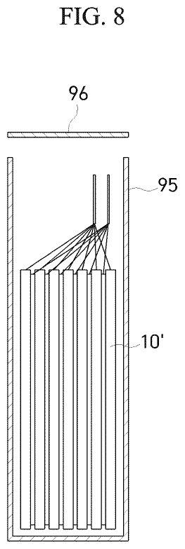

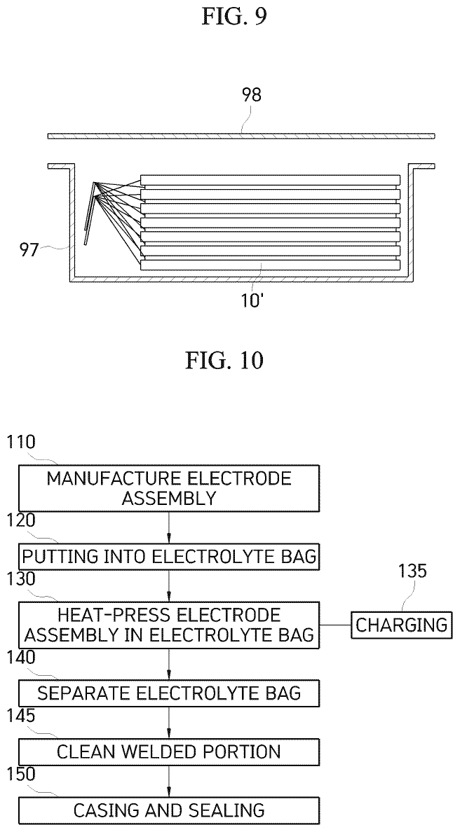

As illustrated in FIGS. 8 and 9, the electrode assembly 10′ on which the electrode plates have been bound through the above-mentioned process is inserted and sealed in a metal case 95 or 97.

FIG. 8 is a schematic view illustrating a case 95 having a vertical prismatic shape or a cylindrical secondary battery. The electrode assembly 10′ may be inserted in the case 95 having an external shape similar to that illustrated in FIG. 3 and sealed by welding a cap plate 96.

FIG. 9 is a schematic view illustrating a case 97 having a horizontal prismatic shape or coin-type secondary battery. The electrode assembly 10′ may be inserted horizontally in the case 97 and sealed by welding a top plate 98. The example shown in FIG. 9 may also be applied to a pouch-type secondary battery.

FIGS. 8 and 9 do not illustrate current collectors for connecting the electrode tabs of the electrode assembly 10′ to the external terminals, which may be included in an actual implementation, and other components used and/or required for manufacturing the secondary battery, such as vent holes, internal insulating plates, and retainers.

FIG. 10 is a flowchart describing a method of manufacturing a secondary battery including a heat pressing (or HPC) method according to some embodiments of the present disclosure. The method of manufacturing a secondary battery according to this embodiment may include manufacturing an electrode assembly (110), inputting the electrode assembly into a flexible electrolyte bag containing an electrolyte (120), heat pressing from the outside of the electrolyte bag to bind electrode plates of the electrode assembly immersed in the electrolyte (130) while optionally concurrently (or simultaneously) charging the electrode assembly 135, separating the electrolyte bag to extract the electrode assembly with the bound electrode plates (140), cleaning welds to be welded when sealing the extracted electrode assembly in an enclosure (145), and inserting and sealing the extracted electrode assembly with cleaned welds in the enclosure (150).

According to this embodiment, the method further includes cleaning the welds before sealing the electrode assembly 10′ with the bound electrode plates in the enclosure (145). In the performing heat pressing (130) as illustrated in FIGS. 6 and 7, the electrolyte bag is pressed together with the electrode assembly. Hence, the electrolyte may overflow, thereby contaminating the electrode tabs 14 and 15 of the electrode assembly. Because current collectors are welded to the electrode tabs 14 and 15 for sealing in the enclosure, this contaminated area should be cleaned.

FIG. 11 is a flowchart describing a method of manufacturing a secondary battery including a heat pressing (or HPC) method according to other embodiments of the present disclosure. The method of manufacturing secondary batteries according to this embodiment may include manufacturing an electrode assembly (110), inputting the electrode assembly into a flexible electrolyte bag containing an electrolyte (120), performing heat pressing from the outside of the electrolyte bag to bind electrode plates of the electrode assembly immersed in the electrolyte (130) while, optionally, concurrently (or simultaneously) charging the electrode assembly 135, separating the electrolyte bag to extract the electrode assembly with the bound electrode plates (140), inserting and sealing the extracted electrode assembly in an enclosure (150), and additionally injecting an electrolyte after sealing in the enclosure (160).

According to this embodiments, the method further includes additionally injecting the electrolyte after sealing the electrode assembly 10′ on which the electrode plates have been bound by the heat pressing (or HPC) method in the enclosure (160). When explaining step 120 above, it was mentioned that the electrolyte 85 contained in the electrolyte bag 81 may omit additives that are usually present in the regular electrolyte injected after sealing in the enclosure, and in this embodiment, the method may further include additionally injecting the regular electrolyte after step 150 (see, e.g., FIG. 11). In the embodiment illustrated in FIG. 11, the method includes additionally injecting a regular electrolyte after sealing in the enclosure (160). However, adding the electrolyte (160) is not applicable only when the electrolyte omitting additives is contained in the electrolyte bag in step 120. For example, if the amount of electrolyte contained in the electrode assembly is not sufficient after the electrolyte bag is separated in step 140 after performing heat pressing, electrolyte (160) may be added as in this embodiment.

Hereinafter, suitable materials that may be usable for the secondary battery according to embodiments of the present disclosure will be described.

As the positive electrode active material, a compound capable of reversibly intercalating/deintercalating lithium (e.g., a lithiated intercalation compound) may be used. For example, at least one of a composite oxide of lithium and a metal selected from cobalt, manganese, nickel, and combinations thereof may be used.

The composite oxide may be a lithium transition metal composite oxide, and examples thereof may include a lithium nickel-based oxide, a lithium cobalt-based oxide, a lithium manganese-based oxide, a lithium iron phosphate-based compound, a cobalt-free nickel-manganese-based oxide, or a combination thereof.

As an example, a compound represented by any one of the following formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}CO_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GₑO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the above formulas: A is Ni, Co, Mn, or a combination thereof; X is Al, Ni, Co, Mn, Cr, Fe, Mg, Sr, V, a rare earth element, or a combination thereof; D is O, F, S, P, or a combination thereof; G is Al, Cr, Mn, Fe, Mg, La, Ce, Sr, V, or a combination thereof; and L¹ is Mn, Al, or a combination thereof.

A positive electrode for a lithium secondary battery may include a substrate and a positive electrode active material layer formed on the substrate. The positive electrode active material layer may include a positive electrode active material and may further include a binder and/or a conductive material.

The content of the positive electrode active material is in a range of about 90 wt % to about 99.5 wt % on the basis of 100 wt % of the positive electrode active material layer, and the content of the binder and the conductive material is in a range of about 0.5 wt % to about 5 wt %, respectively, on the basis of 100 wt % of the positive electrode active material layer.

The substrate may be aluminum (Al) but is not limited thereto.

The negative electrode active material may include a material capable of reversibly intercalating/deintercalating lithium ions, lithium metal, an alloy of lithium metal, a material capable of being doped and undoped with lithium, or a transition metal oxide.

The material capable of reversibly intercalating/deintercalating lithium ions may be a carbon-based negative electrode active material, which may include, for example, crystalline carbon, amorphous carbon, or a combination thereof. Examples of the crystalline carbon may include graphite, such as natural graphite or artificial graphite, and examples of the amorphous carbon may include soft carbon, hard carbon, a pitch carbide, a meso-phase pitch carbide, sintered coke, and the like.

A Si-based negative electrode active material or a Sn-based negative electrode active material may be used as the material capable of being doped and undoped with lithium. The Si-based negative electrode active material may be silicon, a silicon-carbon composite, SiOₓ (0<x<2), a Si-based alloy, or a combination thereof.

The silicon-carbon composite may be a composite of silicon and amorphous carbon. According to one embodiment, the silicon-carbon composite may be in the form of a silicon particle and amorphous carbon coated on the surface of the silicon particle.

The silicon-carbon composite may further include crystalline carbon. For example, the silicon-carbon composite may include a core including crystalline carbon and silicon particle and an amorphous carbon coating layer on the surface of the core.

A negative electrode for a lithium secondary battery may include a substrate and a negative electrode active material layer disposed on the substrate. The negative electrode active material layer may include a negative electrode active material and may further include a binder and/or a conductive material.

For example, the negative electrode active material layer may include about 90 wt % to about 99 wt % of a negative electrode active material, about 0.5 wt % to about 5 wt % of a binder, and about 0 wt % to about 5 wt % of a conductive material.

A non-aqueous binder, an aqueous binder, a dry binder, or a combination thereof may be used as the binder. When an aqueous binder is used as the negative electrode binder, a cellulose-based compound capable of imparting viscosity may be further included.

As the negative electrode substrate, one selected from copper foil, nickel foil, stainless steel foil, titanium foil, nickel foam, copper foam, conductive metal-coated polymer substrate, and combinations thereof may be used.

An electrolyte for a lithium secondary battery may include a non-aqueous organic solvent and a lithium salt.

The non-aqueous organic solvent acts as a medium through which ions involved in the electrochemical reaction of the battery can move.

The non-aqueous organic solvent may be a carbonate-based, an ester-based, an ether-based, a ketone-based, an alcohol-based solvent, an aprotic solvent, and may be used alone or in combination of two or more.

In addition, when a carbonate-based solvent is used, a mixture of cyclic carbonate and chain carbonate may be used.

Depending on the type of lithium secondary battery, a separator may be present between the first electrode plate (e.g., the negative electrode) and the second electrode plate (e.g., the positive electrode). As the separator, polyethylene, polypropylene, polyvinylidene fluoride, or a multilayer film including two or more layers thereof may be used.

The separator may include a porous substrate and a coating layer including an organic material, an inorganic material, or a combination thereof on one or both surfaces of the porous substrate.

The organic material may include a polyvinylidene fluoride-based polymer or a (meth)acrylic polymer.

The inorganic material may include inorganic particles selected from Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and combinations thereof but is not limited thereto.

The organic material and the inorganic material may be mixed in one coating layer or may be in the form of a coating layer including (or containing) an organic material and a coating layer including (or containing) an inorganic material that are stacked on each other.

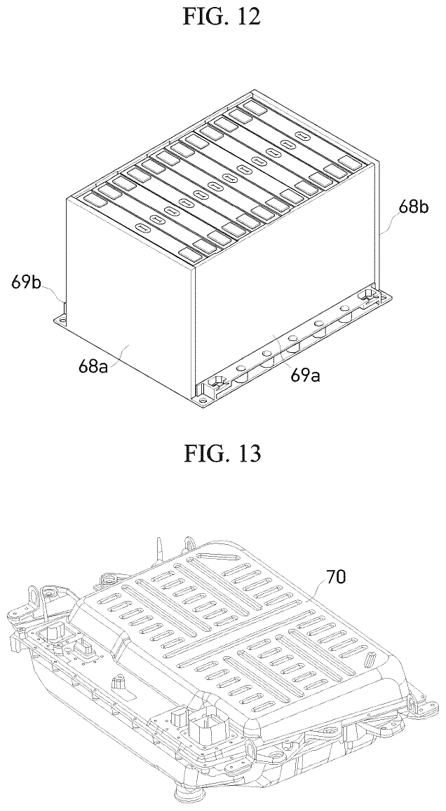

FIG. 12 is a perspective view of a secondary battery module in which prismatic secondary batteries are arranged according to embodiments of the present disclosure. With the increase in secondary battery capacity for driving electric vehicles or the like, a secondary battery module may be manufactured by arranging a plurality of secondary battery cells transversely and/or longitudinally and connecting them together. The plurality of secondary batteries may be arranged in a space defined by a pair of facing end plates 68a and 68b and a pair of facing side plates 69a and 69b. The secondary batteries may be arranged in an arrangement (direction) and number to obtain desired voltage and current specifications.

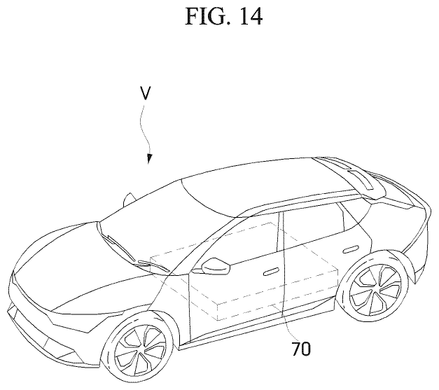

FIG. 13 is a perspective view of a battery pack 70 according to embodiments of the present disclosure. Referring to FIG. 13, the battery pack 70 may include an assembly to which individual batteries are electrically connected and a pack housing accommodating the same. In the drawings, for convenience of illustration, components including a bus bar, a cooling unit, external terminals for electrically connecting batteries, etc., are not shown.

The battery pack 70 may be mounted on (or in) a vehicle. The vehicle may be, for example, an electric vehicle, a hybrid vehicle, or a plug-in hybrid vehicle. The vehicle may be a four-wheeled vehicle or a two-wheeled vehicle but is not limited thereto. FIG. 14 shows a vehicle V that includes the battery pack 70 shown in FIG. 16 on the lower body thereof. The vehicle V may operate by (e.g., may be powered by) receiving power from the battery pack 70.

Although the vehicle V is illustrated as an example above, the secondary battery according to some embodiments of the present disclosure may also be used in small devices, such as mobile phones.

According to embodiments of the present disclosure, the heat pressing can be performed before sealing the electrode assembly in the enclosure. Therefore, even in the secondary battery having a metal enclosure or case, the thickness of the electrode assembly can be controlled through the binding of the electrode plates thereof, increasing energy density while providing a compact size.

Although the present disclosure has been described above with respect to embodiments thereof, the present disclosure is not limited thereto. Various modifications and variations can be made thereto by those skilled in the art within the spirit of the present disclosure and the equivalent scope of the appended claims.

What is claimed is:

1. A method of heat-pressing a secondary battery electrode assembly, the method comprising:
manufacturing an electrode assembly;
inputting the electrode assembly into a flexible electrolyte bag containing an electrolyte; and
heat pressing, from the outside of the electrolyte bag, the electrode assembly immersed in the electrolyte to bind electrode plates of the electrode assembly.

2. The method as claimed in claim 1, wherein the heat pressing comprises charging the electrode assembly.

3. The method as claimed in claim 1, wherein the electrolyte bag comprises a release layer on its inner wall.

4. The method as claimed in claim 1, wherein the electrolyte contained in the electrolyte bag has the same composition as an electrolyte injected into a secondary battery.

5. The method as claimed in claim 1, wherein the electrolyte contained in the electrolyte bag has a composition omitting additives from an electrolyte injected into a secondary battery.

6. The method as claimed in claim 1, wherein first and second electrode tabs of the electrode assembly extend out of the electrolyte without being immersed therein.

7. The method as claimed in claim 1, wherein a distance margin between a level of the electrolyte contained in the electrolyte bag and an open end of the electrolyte bag is set such that the electrolyte does not overflow from the electrolyte bag when the electrode assembly is immersed therein.

8. The method as claimed in claim 1, wherein the heat pressing comprises heating and pressing both sides of the electrode assembly immersed in the electrolyte contained in the electrolyte bag by first and second heat presses.

9. The method as claimed in claim 1, wherein the heat pressing comprises pressing the electrolyte bag and the electrode assembly therein from one side of the electrolyte bag between a support wall and one heat press.

10. The method as claimed in claim 1, wherein the heat pressing comprises collecting the electrolyte overflowing from the electrolyte bag to discharge the same to a drain.

11. A secondary battery comprising:
an electrode assembly comprising electrode plates bound by heat-pressing, the heat-pressing comprises inputting the electrode assembly into a flexible electrolyte bag containing an electrolyte, heat pressing the electrode assembly from the outside of the electrolyte bag to bind the electrode plates of the electrode assembly immersed in the electrolyte, and separating the electrolyte bag to extract the electrode assembly with the bound electrode plates; and
an enclosure accommodating the electrode assembly.

12. The secondary battery as claimed in claim 11, wherein the electrode assembly is concurrently charged and heat-pressed.

13. The secondary battery as claimed in claim 11, wherein the enclosure comprises metal.

14. A method of manufacturing a secondary battery, the method comprising:
manufacturing an electrode assembly;
inputting the electrode assembly into a flexible electrolyte bag containing an electrolyte;
heat pressing, from the outside of the electrolyte bag, the electrode assembly that is immersed in the electrolyte to bind electrode plates of the electrode assembly;
separating the electrolyte bag to extract the electrode assembly with bound electrode plates; and
inserting and sealing the extracted electrode assembly in an enclosure.

15. The method as claimed in claim 14, wherein the heat pressing comprises charging the electrode assembly.

16. The method as claimed in claim 14, wherein the electrolyte bag comprises a release layer on its inner wall.

17. The method as claimed in claim 14, wherein the inserting and sealing the extracted electrode assembly in the enclosure comprises vertically inserting the electrode assembly in a vertical enclosure and sealing the same by welding a cap plate.

18. The method as claimed in claim 14, wherein the inserting and sealing the extracted electrode assembly in the enclosure comprises horizontally inserting the electrode assembly in a horizontal enclosure and sealing the same by welding a top plate.

19. The method as claimed in claim 14, further comprising cleaning a weld of the electrode assembly before sealing the extracted electrode assembly in the enclosure.

20. The method as claimed in claim 14, further comprising injecting an electrolyte after sealing the extracted electrode assembly in the enclosure.
